(19) United States
(12) Patent Application Publication
(10) Pub. No.: US 2017/0007479 A1
(43) Pub. Date: Jan. 12, 2017

(54) LIFT CHAIR

(71) Applicants: Amy Armenta, Oklahoma City, OK (US); Kenneth Bradley, Oklahoma City, OK (US); Alex Brown, Spencer, OK (US); Daisy Mezano Fuentes, Oklahoma City, OK (US); Arynn Jawaughn Howell, Oklahoma City, OK (US); Nathan Pratt, Oklahoma City, OK (US)

(72) Inventors: Amy Armenta, Oklahoma City, OK (US); Kenneth Bradley, Oklahoma City, OK (US); Alex Brown, Spencer, OK (US); Daisy Mezano Fuentes, Oklahoma City, OK (US); Arynn Jawaughn Howell, Oklahoma City, OK (US); Nathan Pratt, Oklahoma City, OK (US)

(21) Appl. No.: 15/206,727

(22) Filed: Jul. 11, 2016

Related U.S. Application Data
(60) Provisional application No. 62/191,154, filed on Jul. 10, 2015.

(51) Int. Cl. A61G 5/14; A47C 7/00

(52) U.S. Cl. CPC A61G 5/14; A47C 7/00; A47C 7/006

(57) ABSTRACT

The presently disclosed inventive concepts relate generally to lift chairs, such as a lift chair comprising a frame having a back portion and a front portion defining an interior space, and a first horizontal member positioned between the back portion and the front portion; a foot platform positioned at least partially in the interior space of the frame, the foot platform having a lowered position and a raised position; a seat positioned at least partially in the interior space of the frame and above the platform and pivotally connected to the first horizontal member, the seat having a first end portion and a second end portion, and pivotable between a standing position and a seated position; and a motion translation system configured such that pivoting the seat between the standing position and the seated position moves the platform vertically between the lowered position and the raised position.

### INCORPORATION BY REFERENCE

The present patent application claims priority to Provisional Patent Application U.S. Ser. No. 62/191,154 titled LIFT CHAIR, filed on Jul. 10, 2015, the entire contents of which are hereby expressly incorporated herein by reference.

### FIELD OF TECHNOLOGY

The presently disclosed and/or claimed inventive concept(s) relates generally to lift chairs.

### BACKGROUND

Many people find it difficult to perform the simple act of sitting down in a chair or getting up from a chair. Advanced age, injuries or various physical disabilities can make it hard for a person to comfortably sit down in a chair or stand up from the chair. Sitting and standing is a whole body movement. It requires virtually every part of the body to work together. If one part of the body is weakened or injured, then the process of sitting or standing can become awkward and even dangerous. To address this problem, various “lift chairs” and lifting devices have been invented. Many lift chairs are very large, expensive and contain many complicated components. Other lifting devices are smaller and portable. They are designed to be placed on the seat portion of an existing chair. These devices can present a significant safety hazard. A seated person could be accidentally propelled out of their seat as a result of the lifting mechanism. A need exists for a relatively simple, inexpensive and safe lift chair or lifting device.

### BRIEF SUMMARY OF THE DRAWINGS

FIG. 1 is a perspective view of an embodiment of an exemplary lift chair in accordance with the inventive concepts disclosed herein.

FIG. 2 is a perspective view of another embodiment of an exemplary lift chair in accordance with the inventive concepts disclosed herein.

FIG. 3 is a perspective view of yet another embodiment of an exemplary lift chair in accordance with the inventive concepts disclosed herein.

FIG. 4A is a cross-sectional view in a first position taken along line 4-4 of FIG. 3.

FIG. 4B is a cross-sectional view in a second position taken along line 4-4 of FIG. 3 of the lift chair.

FIG. 5 is a perspective view of still another embodiment of an exemplary lift chair in accordance with the inventive concepts disclosed herein

FIG. 6A is a cross-sectional view in a first position taken along line 6-6 of FIG. 5.

FIG. 6B is a cross-sectional view in a second position taken along line 6-6 of FIG. 5.

### DETAILED DESCRIPTION

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of ordinary skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the qualifying term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the qualifying term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

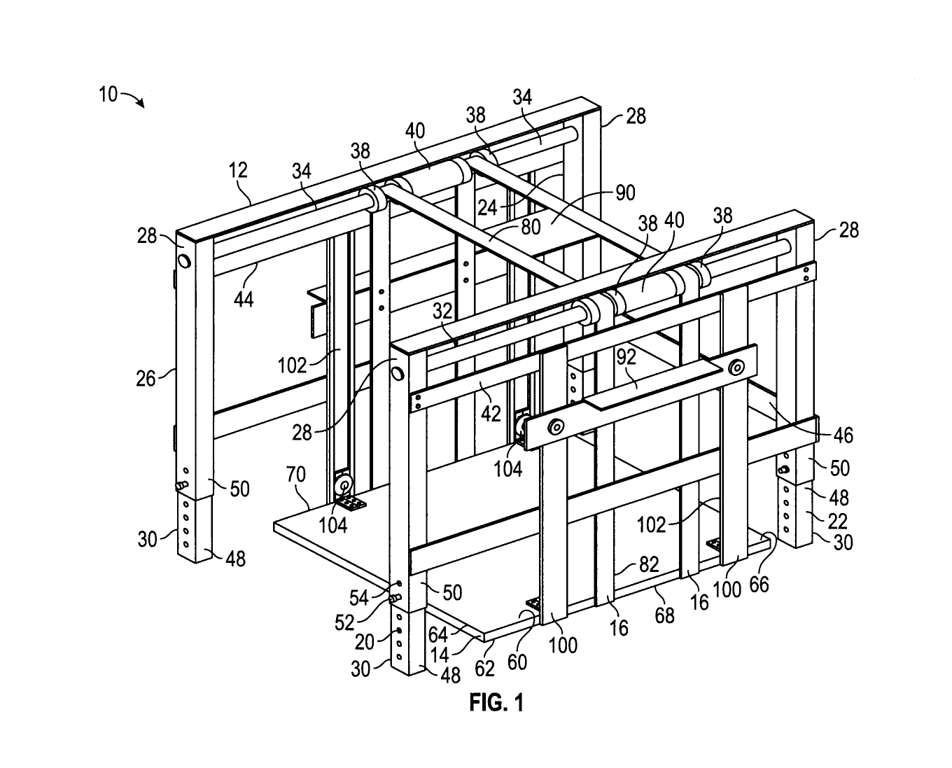

Referring now to the figures, FIG. 1 illustrates an exemplary lift chair 10 comprising a frame 12, a platform 14, and one or more bands 16.

The frame may comprise two or more legs. In one embodiment, the frame may comprise a first leg 20, a second leg 22, a third leg 24, and a fourth leg 26. Each leg has a top portion 28 and a bottom portion 30. The frame 12 may have a first cross member 32 extending from the top portion 28 of the first leg 20 to the top portion 28 of the second leg 22 and a second cross member 34 extending from the top portion 28 of the third leg 24 to the top portion 28 of the fourth leg 26. The second cross member 34 may comprise one or more rotatable sections (not pictured). Additionally or alternately, the frame may further comprise one or more rotatable members 38. The rotatable members 38 may be rotatably connected to the first and the second cross members 32, 34. Nonexclusive examples of the rotatable members 38 include pulleys, wheels, rollers, bearings, and combinations thereof.

In one embodiment, the frame 12 may further comprise a first rotatable member 38, such as a pulley, and a second rotatable member 38, such as a pulley, in a spaced apart relationship on the first cross member 32. The first and second rotatable members 38 may be separated by one or more spacer 40. The frame 12 may also comprise a third rotatable member 38, such as a pulley, and a fourth rotatable member 38, such as a pulley, in a spaced apart relationship on the second cross member 34. The third and the cross rotatable members 38 may be separated by one or more spacer 40.

In one embodiment, the frame 12 may further comprise a first support member 42 and a second support member 44, the first support member 42 extending from the first leg 20 to the second leg 22, and the second support member 44 extending from the third leg 24 to the fourth leg 26, the first and the second support members 42, 44 positioned below the first and the second cross members 32, 34.

In one embodiment, the frame 12 may further comprise a third support member 46 between the second leg 22 and the third leg 24. Of course it will be understood that more or fewer support members may be used, for example, based on the size and material and shape of the frame 12.

The frame 12 may be made of wood, metal, aluminum, plastic, PVC pipe, tubular metal bar, other suitable materials, or any combination thereof.

In one embodiment, the first, the second, the third, and/or the fourth legs 20, 22, 24, 26 may be longitudinally adjustable. In one embodiment, each of the first, the second, the third, and the fourth legs 20, 22, 24, 26 is comprised of a first section 48, a second section 50, and at least one connector 52. The first section 48 may be insertable within the second section 50. In one embodiment, each of the first and the second sections 48, 50 may have at least one side having through-holes 54. The connector 52 may join the first and the second sections 48, 50 via the through-holes 54 when at least one through-hole 54 of the first section 48 is aligned with at least one through-hole 54 of the second section 50. Non-exclusive examples of the connector 52 include pins, bolts, screws, and clips. Of course, it will be understood that the first, the second, the third, and/or the fourth legs 20, 22, 24, 26 may be longitudinally adjusted in other manners, well known to those having skill in the art.

The platform 14 may be positioned at least partially between the first, the second, the third, and/or the fourth legs 20, 22, 24, 26. The platform 14 may have a top 60, a bottom 62, a front end 64, a back end 66, and a first side 68 and a second side 70 extending between the front end 64 and the back end 66 and the top 60 and the bottom 62.

The one or more bands 16 may have a top portion 80 and a bottom portion 82. The bottom portion 82 may be connected to the platform 14. The one or more bands 16 may extend from the first side 68 of the platform 14 over the first and the second cross members 32, 34 to the second side 70 of the platform 14. The top portion 80 of the one or more bands 16 may extend over at least one of the rotatable sections (not pictured) and/or the rotatable members 38 rotatably connected to the first and the second cross members 32, 34. The term “band” may encompass, but is not limited to, belts, seat belts, webbing, cable, rope, line, wire, chain, fiber, material strips, woven material, and any combination thereof.

In one embodiment, the one or more bands 16 may be continuous, extending about the platform 14 and over the first and the second cross members 32, 34.

In one embodiment, the length of the one or more bands 16 may be adjustable.

In one embodiment, the lift chair 10 may further comprise a movable seat 90 attached to the one or more bands 16 and vertically movable. The seat 90 may be positioned at least partially in an area defined by the two or more legs. In such an embodiment, the one or more bands 16 may extend from the first side 68 of the platform 14 over the first cross member 32 and connect to the seat 90 and the one or more bands 16 may extend from the second side 70 of the platform 14 over the second cross member 34 and connect to the seat 90.

In one embodiment, the lift chair 10 may further comprise one or more band handles 92 connected to the one or more bands 16.

As illustrated in FIG. 1, in one embodiment, the lift chair 10 may further comprise one or more handle guides 100. In one embodiment, the one or more handle guides 100 extend along, and are vertically aligned with, the bands 16 such that the band handle 92 travels substantially vertically and remains substantially level. In one embodiment, the one or more handle guides 100 may extend perpendicularly from the first and the second support members 42, 44.

In one embodiment, the frame 12 may further comprise one or more platform guides 102 and the platform 14 may comprise one or more rollers 104 longitudinally movable in the platform guides 102. In one embodiment, the one or more platform guides 102 comprises a groove on the surface of the one or more handle guides 100 facing the interior of the lift chair 10. In one embodiment, the one or more platform guides 102 are four platform guides 102 and the one or more rollers 104 are four rollers 104. In one embodiment, one or more of the rollers 104 is positioned proximate to the corners of the platform 14. Nonexclusive examples of rollers include, rolls, wheels, bearings, slides, ratchets, chains, and so on.

In one embodiment, the lift chair 10 may further comprise one or more band guides (not shown) at least partially encompassing the one or more bands such that the lateral movement of the bands is restricted.

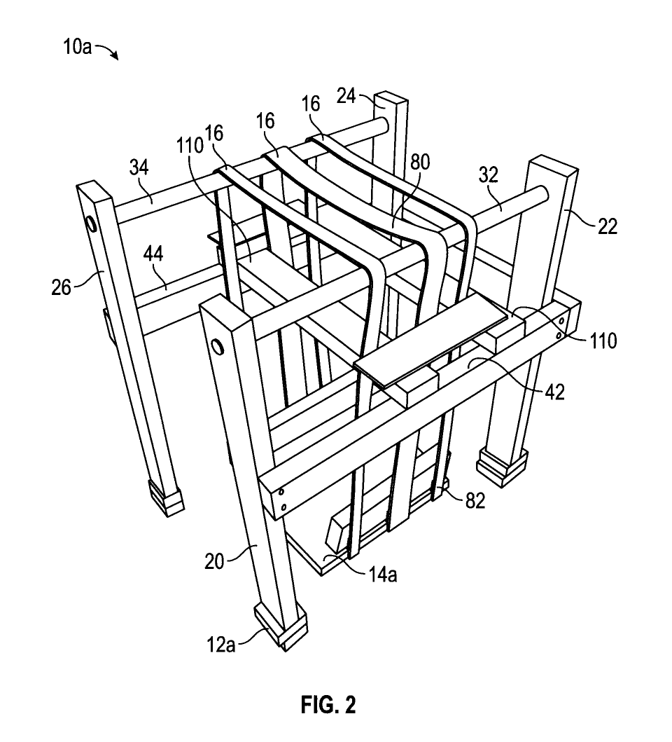

FIG. 2 illustrates another embodiment of a lift chair 10a constructed in accordance with the inventive concepts disclosed herein. The lift chair 10a is substantially similar to the lift chair 10, except as described herein below. As shown in FIG. 2, the lift chair 10a may further comprise one or more seat members 110 positioned below the top portion 80 of the one or more bands 16 and below the first and the second cross members 32, 34. As illustrated in FIG. 2, in one embodiment, the frame 12a may further comprise a first seat member 110 and a second seat member 110, extending from the first support member 42 to the second support member 44, and positioned below the first and the second cross members 32, 34. In one embodiment, the lift chair 10a may further comprise a seat (not pictured) connected to the first and the second support members 42, 44 and/or connected to one or more seat members 110. In one non-limiting example, a chair or stool (not shown) may be placed within the frame 12a to act as the seat (not pictured) and/or to take the place of the seat members 110. A platform 14a may be positioned vertically beneath the seat (not pictured) and extending toward the first and the fourth legs 20, 26

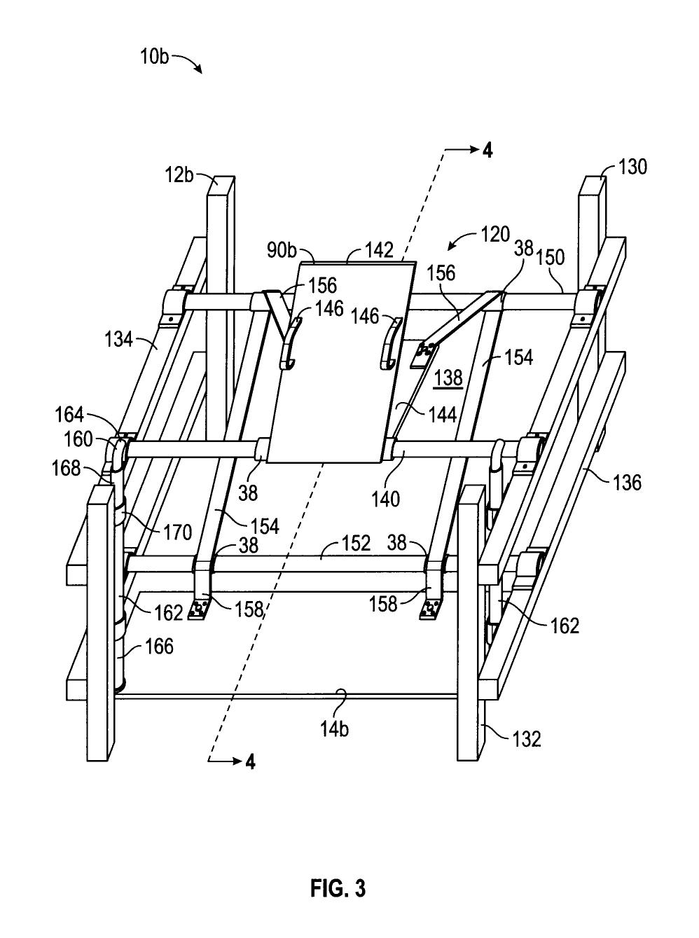

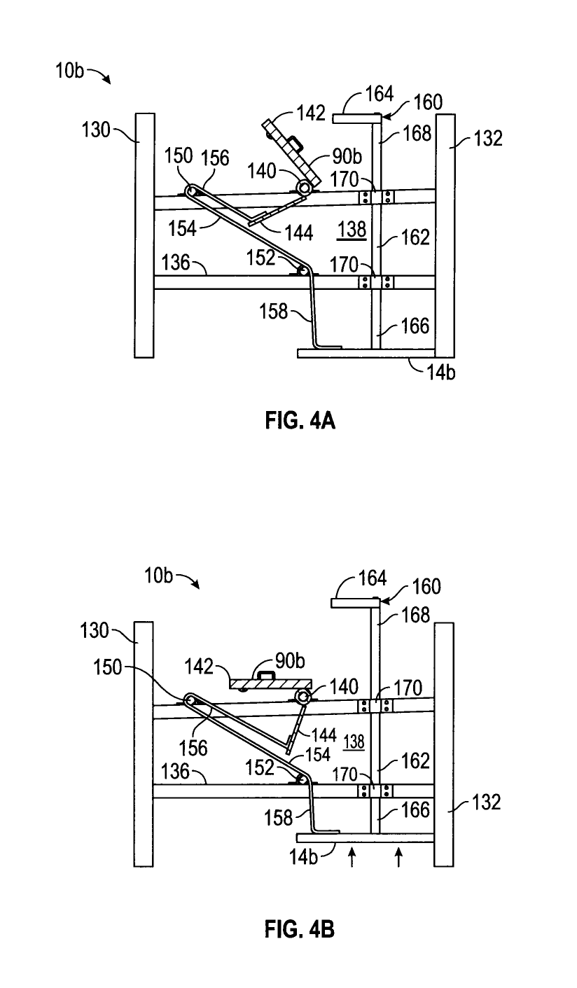

FIGS. 3, 4A, and 4B illustrate another embodiment of a lift chair 10b constructed in accordance with the inventive concepts disclosed herein. The lift chair 10b comprises a frame 12b, a foot platform 14b, a seat 90b, and a motion translation system 120.

The frame 12b has a back portion 130 and a front portion 132, and a first side 134 and a second side 136 connecting the back portion 130 and the front portion 132. The back portion 130, the front portion 132, the first side 134, and the second side 136 define an interior space 138. The frame 12b has a first horizontal member 140 positioned between the back portion 130 and the front portion 132. The first horizontal member 140 may be connected to the first side 134 and the second side 136, or otherwise supported by the frame 12b.

The foot platform 14b is positioned at least partially in the interior space 138 of the frame 12b. The foot platform 14b has a lowered position and a raised position.

The seat 90b is positioned at least partially in the interior space 138 of the frame 12b and above the platform 14b. The seat 90b has a first end portion 142 and a second end portion 144 and is pivotally connected to the first horizontal member 140. The seat 90b is pivotable between a standing position and a seated position. In one embodiment, in the standing position the first end portion 142 of the seat 90b is positioned at an angle above a horizontal plane, and in the seated position the first end portion 142 is substantially parallel to the horizontal plane. In one embodiment, in the standing position the first end portion 142 of the seat 90b is positioned above the horizontal plane at an angle of less than ninety degrees. In one embodiment, the “horizontal plane” is substantially parallel to the platform 14b.

In one embodiment, the seat 90b is “v” shaped such that the second end portion 144 is angularly positioned from the first end portion 142. The seat 90b may be pivotally connected to the first horizontal member 140 between the first end portion 142 and the second end portion 144 of the seat 90b.

In one embodiment, the lift chair 10b further comprises one or more seat hand grips 146 connected to the first end portion of the seat 90b.

In one embodiment, the lift chair 10b comprises one or more rotatable member 38 positioned about the first horizontal member 140, and the seat 90b is connected to the rotatable member 38 pivotable about the first horizontal member 140

In one embodiment, the motion translation system 120 comprises a first cylindrical member 150 connected to the frame 12b proximate to the back portion 130 of the frame 12b, a second cylindrical member 152 connected to the frame 12b and positioned between the first cylindrical member 150 and the front portion 132 of the frame 12b, and one or more connector 154 connecting the seat 90b and the platform 14b.

In one embodiment, the first horizontal member 140 and the second cylindrical member 152 are substantially in a same vertical plane.

The one or more connector 154 has a first end 156 and a second end 158. In one embodiment, the first end 156 of the one or more connector 154 is connected to the second end portion 144 of the seat 90b and the second end 158 of the one or more connector 154 is connected to the platform 14b. The one or more connector 154 is movably positioned about the first cylindrical member 150 and the second cylindrical member 152, such that pivoting the seat 90b between the standing position and the seated position moves the platform 14b vertically between the lowered position and the raised position. Likewise, the one or more connector 154 is movably positioned about the first cylindrical member 150 and the second cylindrical member 152, such that moving the platform 14b vertically between the lowered position and the raised position pivots the seat 90b between the standing position and the seated position.

In one embodiment, the first cylindrical member 150 and the second cylindrical member 152 are rotatable.

In one embodiment, the one or more connector 154 is movably positioned about the first cylindrical member 150 and over the second cylindrical member 152. In one embodiment the first cylindrical member 150 has one or more rotatable member 38, such as a first pulley, the second cylindrical member has one or more rotatable member 38, such as a second pulley, and the connector 154 is positioned about the first rotatable member 38 and the second rotatable member 38.

In one embodiment, the lift chair 10b may further comprise one or more hand support 160 connected to the platform 14b. The one or more hand support 160 may include a vertical member 162 and a handle 164, which in one non-exclusive embodiment, may be horizontal. The vertical member 162 has a first end 166 connected to the foot platform 14b and a second end 168 connected to the handle 164. The one or more hand support 160 may be slidably connected to the frame 12b between the first end 166 and the second end 168 of the vertical member 162 of the hand support 160. In one embodiment, the hand support 160 is slidably connected to the frame 12b via a bracket 170, though other fasteners that allow for vertical movement may be used.

In one embodiment, the one or more connector 154 may comprise one or more bands 16b. The term “band” may encompass, but is not limited to, belts, seat belts, webbing, cable, rope, line, wire, chain, fiber, material strips, woven material, and any combination thereof.

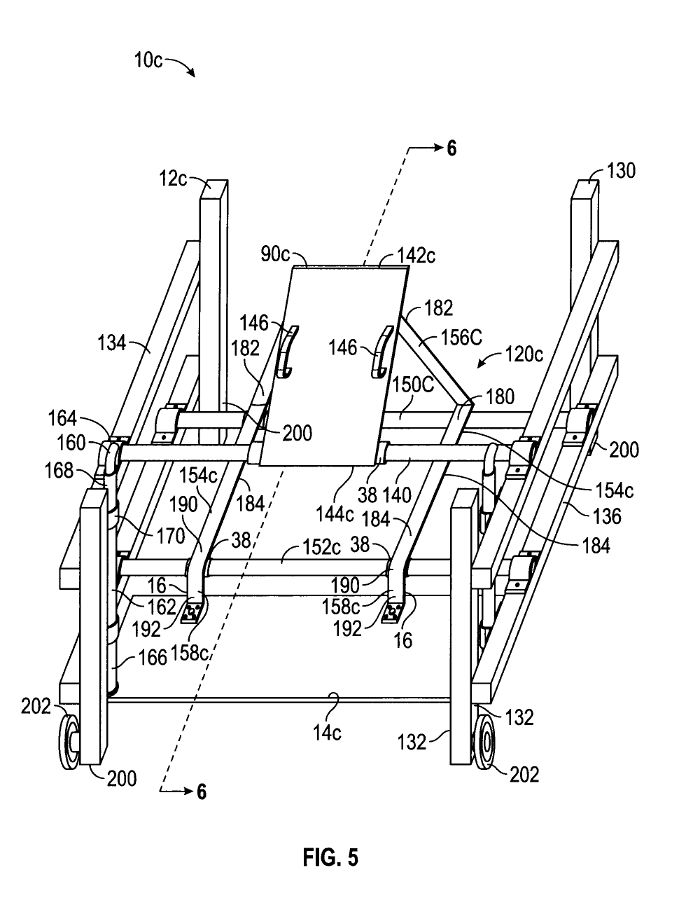

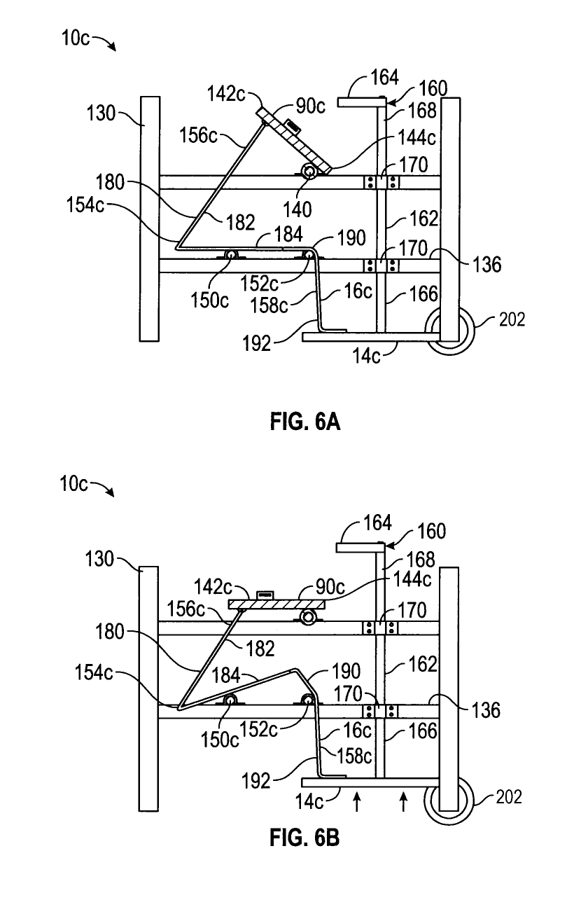

FIGS. 5A, 5B and 5C illustrate another embodiment of a lift chair 10c constructed in accordance with the inventive concepts disclosed herein. The lift chair 10c is substantially similar to the lift chair 10b, except as described herein below.

The lift chair 10c may have a seat 90c having a first end portion 142c and a second end portion 144c. The motion translation system 120c may comprise a first cylindrical member 150c connected to the frame 12c proximate to the back portion 130 of the frame 12c, a second cylindrical member 152c connected to the frame 12c and positioned between the first cylindrical member 150c and the front portion 132 of the frame 12c, and one or more connector 154c having a first end 156c connected to the first end portion 142c of the seat 90c and a second end 158c connected to the platform 14b. The one or more connector 154c is pivotable about the first cylindrical member 150c and movable about the second cylindrical member 152c, such that pivoting the seat 90c between the standing position and the seated position moves the platform 14c vertically between the lowered position and the raised position and such that moving the platform 14c vertically between the lowered position and the raised position pivots the seat 90c between the standing position and the seated position.

In one embodiment, the first end 156c of the one or more connector 154c of the lift chair 10c comprises a rigid member 180 having a first arm 182 and a second arm 184 angularly positioned from the first arm 182. The first arm 182 is connected to the first end portion 142c of the seat 90c, and the second arm 184 is connected to the second end 158c of the one or more connector 154c. The rigid member 180 is pivotable about the first cylindrical member 150c.

In one embodiment, the second end 158c of the one or more connector 154c comprises one or more band 16c having a first end portion 190 and a second end portion 192. The first end portion 190 of the one or more band 16c is movable about the second cylindrical member 152c and connected to the second arm 184 of the rigid member 180, such that rotation of the rigid member 180 moves the band 16c about the second cylindrical member 152c. The second end portion 192 of the one or more band 16c is connected to the platform 14b, such that rotation of the rigid member 180 moves the band 16c about the second cylindrical member 152c such that the platform 14c moves between the lowered position and the raised position.

In one embodiment, the first cylindrical member 150c is positioned in a same horizontal plane as the second cylindrical member 152c.

In one embodiment, the frame 12c has a bottom portion 200 and the lift chair 10, 10a, 10b, 10c further comprises two or more wheels 202 connected to the bottom portion of the frame 12, 12a, 12b, 12c. For example, there may be two wheels 202 or four wheels 202 or any number of wheels 202. In such embodiments, the lift chair 10, 10a, 10b, 10c may be utilized as a walker or a wheelchair.

It will be understood that any of the embodiments of the lift chair 10, 10a, 10b, 10c, or combinations of elements thereof, may be utilized.

In use, the lift chair 10, 10a, 10b, 10c has a standing position and a sitting position. In the standing position, as shown in FIGS. 1, 2, 3, and 5 the platform 14, 14a, 14b, 14c is in a lowered position, such as resting on a floor. A user may step on the platform 14, 14a, 14b, 14c, such that the user faces away from the bands 16 and/or seat 90, 90a, 90b, 90c.

Next, the user may begin to lower her weight onto the top portion of the one or more bands 16 and/or seat 90, 90a, 90b, 90c. As the top portion of the one or more bands 16 and/or the first end portion 142, 142c of the seat 90, 90a, 90b, 90c is moved downward by the weight of the user, the platform 14, 14a, 14b, 14c that is connected to the bottom portion of the one or more bands 16 and/or the connector 154, 154c is moved upward from its lowered position. The user is thus moved into a sitting position.

In one embodiment, the user's downward momentum on the one or more bands 16 and/or the first end portion 142, 142c of the seat 90, 90a, 90b, 90c may be stopped by the first and/or second seat member 110 or the first cylindrical member 150, 150c when the user reaches the sitting position, thus limiting the amount of the upward movement of the platform 14, 14a, 14b, 14c and likewise limiting the downward movement of the bands 16 and/or seat 90, 90a, 90b, 90c and/or user.

To move out of the sitting position, in one embodiment, the user may increase the weight on the platform 14, 14a, 14b, 14c, thus creating an upward movement of the one or more the bands 16 and/or seat 90, 90a, 90b, 90c, which may assist the user in rising from the sitting position.

In an embodiment in which the lift chair 10, 10a, 10b, 10c comprises one or more handles and/or hand grips 146, the user may use her hands and/or arms to push the handles 146 down, thereby moving the bands connected to the handles down and/or moving the platform 14, 14a, 14b, 14c down, and thus lowering the platform 14, 14a, 14b, 14c to its lowered position while creating an upward movement of the one or more the bands and/or seat 90, 90a, 90b, 90c, which may assist the user in rising from the sitting position.

What is claimed is:

1. A lift chair, comprising:
a frame comprising:
a first leg having a top portion and a bottom portion;
a second leg having a top portion and a bottom portion;
a first cross member extending from the top portion of the first leg to the top portion of the second leg, the first cross member having one or more rotatable section;
a third leg having a top portion and a bottom portion;
a fourth leg having a top portion and a bottom portion;
a second cross member extending from the top portion of the third leg to the top portion of the fourth leg, the second cross member having one or more rotatable section;
a platform positioned at least partially between the first, second, third, and fourth legs, the platform having a top, and a bottom, a front end, a back end, and a first side and a second side extending between the front end and the back end; and
one or more bands extending from the first side of the platform over the first and second cross members to the second side of the platform.

2. The lift chair of claim 1, further comprising:
one or more handles connected to the one or more bands.

3. The lift chair of claim 1, further comprising:
one or more guides at least partially encompassing the one or more bands such that lateral movement of the bands is restricted.

4. The lift chair of claim 1, further comprising:
a seat, wherein the one or more bands extending from the first side of the platform over the first cross member are connected to the seat and the one or more bands extending from the second side of the platform over the second cross member are connected to the seat.

5. A lift chair, comprising:
a frame having a back portion and a front portion, and a first side and a second side connecting the back portion and the front portion, wherein the back portion, the front portion, the first side, and the second side define an interior space, and a first horizontal member connected to the first side and the second side and positioned between the back portion and the front portion;
a foot platform positioned at least partially in the interior space of the frame, the foot platform having a lowered position and a raised position;
a seat positioned at least partially in the interior space of the frame and above the platform and pivotally connected to the first horizontal member, the seat having a first end portion and a second end portion, and pivotable between a standing position and a seated position; and
a motion translation system comprising a first cylindrical member connected to the frame proximate to the back portion of the frame, a second cylindrical member connected to the frame and positioned between the first cylindrical member and the front portion of the frame, and one or more connector having a first end connected to the second end portion of the seat and a second end connected to the platform, wherein the one or more connector is movably positioned about the first cylindrical member and the second cylindrical member, such that pivoting the seat between the standing position and the seated position moves the platform vertically between the lowered position and the raised position.

6. The lift chair of claim 5, wherein in the standing position the first end portion of the seat is positioned above a horizontal plane, and in the seated position the first end portion is substantially parallel to the horizontal plane.

7. The lift chair of claim 5, wherein the first cylindrical member has a first pulley, the second cylindrical member has a second pulley, and the connector is positioned about the first pulley and the second pulley.

8. The lift chair of claim 7, wherein the connector is positioned about the first pulley and over the second pulley.

9. The lift chair of claim 5, further comprising one or more hand support, the one or more hand support comprising a vertical member and a handle, the vertical member having a first end connected to the foot platform and a second end connected to the handle, the one or more hand support slidably connected to the frame between the first end and the second end of the vertical member of the hand support.

10. The lift chair of claim 5, wherein the seat is “v” shaped such that the second end portion is angularly positioned from the first end portion, and wherein the seat is pivotally connected to the first horizontal member between the first end portion and the second end portion.

11. The lift chair of claim 5, wherein moving the platform vertically between the raised position and the lowered position moves the seat between the seated position and the standing position.

12. The lift chair of claim 5, wherein the one or more connector is one or more bands.

13. The lift chair of claim 5, wherein the frame has a bottom portion and wherein the lift chair further comprises two or more wheels connected to the bottom portion of the frame.

14. The lift chair of claim 5, further comprising one or more hand grips connected to the first end portion of the seat.

15. A lift chair, comprising:
a frame having a back portion and a front portion, and a first side and a second side connecting the back portion and the front portion, wherein the back portion, the front portion, the first side, and the second side define an interior space, and a first horizontal member connected to the first side and the second side and positioned between the back portion and the front portion;
a foot platform positioned at least partially in the interior space of the frame, the foot platform having a lowered position and a raised position;
a seat positioned at least partially in the interior space of the frame and above the platform and pivotally connected to the first horizontal member, the seat having a first end portion and a second end portion, and pivotable between a standing position and a seated position; and
a motion translation system comprising a first cylindrical member connected to the frame proximate to the back portion of the frame, a second cylindrical member connected to the frame and positioned between the first cylindrical member and the front portion of the frame, and one or more connector having a first end connected to the first end portion of the seat and a second end connected to the platform, wherein the one or more connector is pivotable about the first cylindrical member and movable about the second cylindrical member, such that pivoting the seat between the standing position and the seated position moves the platform vertically between the lowered position and the raised position.

16. The lift chair of claim 15, wherein the first end of the one or more connector comprises a rigid member having a first arm and a second arm angularly positioned from the first arm, wherein the first arm is connected to the first end portion of the seat, and the second arm is connected to the second end of the one or more connector, and wherein the rigid member is pivotable about the first cylindrical member.

17. The lift chair of claim 16, wherein the second end of the one or more connector comprises one or more band having a first end portion and a second end portion, wherein the first end portion of the one or more band is movable about the second cylindrical member and connected to the second arm of the rigid member such that rotation of the rigid member moves the band about the second cylindrical member, and wherein the second end portion of the one or more band is connected to the platform, such that rotation of the rigid member moves the band about the second cylindrical member such that the platform moves between the lowered position and the raised position.

18. The lift chair of claim 15, further comprising one or more hand grips connected to the first end portion of the seat.

19. The lift chair of claim 15, further comprising one or more hand support, the one or more hand support comprising a vertical member and a horizontal hand grip, the vertical member having a first end connected to the foot platform and a second end connected to the horizontal hand grip, the one or more hand support slidably connected to the frame between the first end and the second end of the vertical member of the hand support.

20. The lift chair of claim 19, wherein moving the platform vertically between the raised position and the lowered position moves the seat between the seated position and the standing position.
